(19) United States
(12) Patent Application Publication
(10) Pub. No.: US 2025/0322129 A1
(43) Pub. Date: Oct. 16, 2025

(54) BUCKETIZATION SCHEME FOR FUNCTIONAL VERIFICATION

(71) Applicant: Synopsys, Inc., Sunnyvale, CA (US)

(72) Inventors: Danish Jawed, Mansfield, MA (US); Parijat Biswas, Bellandur (IN); Badri Prasad Gopalan, Cupertino, CA (US); Minakshi Chakravorty, Bengaluru (IN)

(21) Appl. No.: 18/426,769

(22) Filed: Jan. 30, 2024

(51) Int. Cl. G06F 30/3308

(52) U.S. Cl. CPC G06F 30/3308

(57) ABSTRACT

An example is a non-transitory computer-readable storage medium including stored instructions. The instructions, which when executed by one or more processors, cause the one or more processors to: obtain an assignment of an assigned bucket; generate stimulus values targeting one or more uncovered bins of the assigned bucket; simulate operation of a circuit design using the stimulus values; determine whether the assigned bucket has been covered by the simulated operation of the circuit design; and expand a size of the assigned bucket following a determination that the assigned bucket has been covered. The assigned bucket, as assigned, has a subset of bins of a functional coverage space.

### TECHNICAL FIELD

The present disclosure relates to functional verification of a circuit design, and more particularly, to bucketizing bins of a functional coverage space for simulation in functional verification.

### BACKGROUND

Designing a circuit may be an arduous process, particularly for today's complex System-on-Chip (SoC) circuits. The design is commonly thoroughly tested to ensure functionality, specifications, and reliability. The importance of these tests prior to tape out and fabrication is significant as the costs and complexity of tape out and fabrication is substantial. Fabricating a circuit that does not meet the necessary specification, does not operate as intended, and/or is not reliable may result in large, wasted costs.

### BRIEF DESCRIPTION OF THE DRAWINGS

The disclosure will be understood more fully from the detailed description given below and from the accompanying figures of embodiments of the disclosure. The figures are used to provide knowledge and understanding of embodiments of the disclosure and do not limit the scope of the disclosure to these specific embodiments. Furthermore, the figures are not necessarily drawn to scale.

FIG. 1A is computer code of an example testbench.

FIG. 1B is computer code of an example testbench according to some examples.

FIG. 2 depicts a functional verification environment according to some examples.

FIG. 3 is a flowchart of a method for functional verification according to some examples.

FIG. 4 depicts a flowchart of various processes used during the design and manufacture of an integrated circuit in accordance with some examples.

FIG. 5 depicts a diagram of an example computer system in which examples may operate.

### DETAILED DESCRIPTION

Aspects of the present disclosure relate to a bucketization scheme for functional verification. Functional verification of a circuit design, which may also be referred to as a design under test (DUT), may be performed during a design process for a circuit or system to test whether the DUT functions as intended. In this functional verification, stimuli may be used as inputs to the DUT during a simulation of operation of the DUT so that a user may observe the functionality of the DUT that results from the stimuli. Generally, a comprehensive functional verification may include simulating operation of the DUT using a large number of sets of stimuli, where the sets of stimuli are diverse to cover many possible scenarios of operation. The functional verification may use a constrained random stimulus generator to generate diverse stimuli to efficiently execute a verification plan and achieve functional coverage goals.

In function verification, such as in regression testing, multiple concurrent simulations may run. For example, hundreds or even thousands of concurrent simulations may be run. Each simulation may be unaware of the state of the other concurrent simulations. As a result, each concurrent simulation that targets the same uncovered functional coverage space results in overlap of holes targeted. A coverage hole may be or include a set of user defined or inferred observation points or values in the design or test bench that were not reached during a simulation. A hole implies that a corresponding condition was not generated and observed during simulation. Targeting holes may be performed to verify that the simulation generated the condition indicated by the hole. Having multiple concurrent simulations target a same hole (e.g., overlap of holes targeted) may reduce the rate of coverage convergence while considering the full regression.

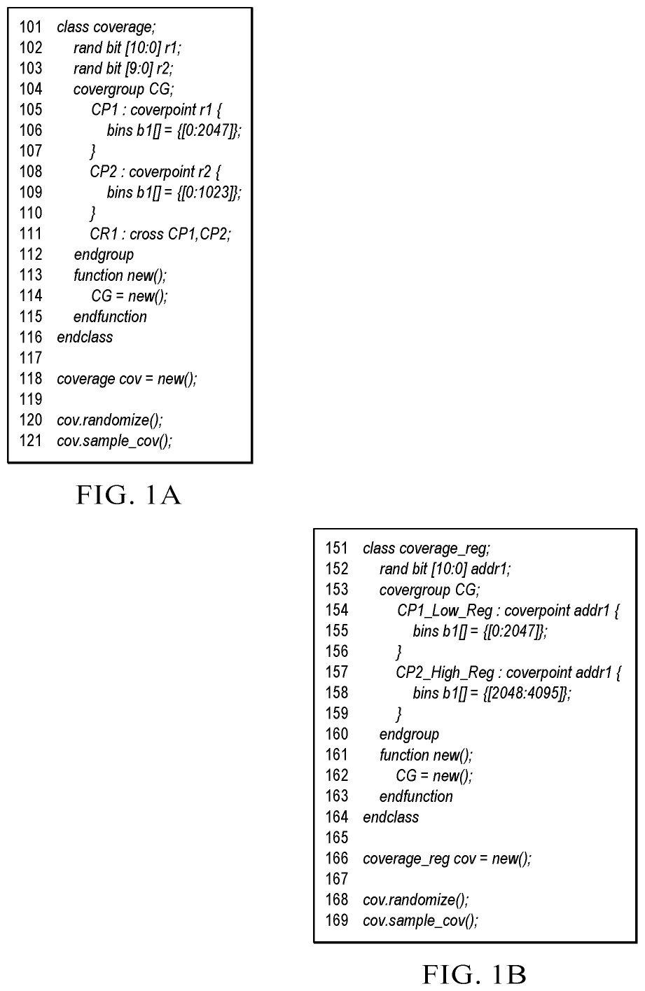

FIG. 1A is computer code of an example testbench. The testbench includes a definition of a class of a functional coverage space. A class of type coverage is defined starting at line 101 and ending at line 116. Random variables r1 and r2 are declared at lines 102, 103. The random variable r1 is connected to coverage-point CP1 at line 105, and the random variable r2 is connected to coverage-point CP2 at line 108. The coverage-point CP1 has bins having respective values in a range from 0 to 2047, as shown at line 106, and the coverage-point CP2 has bins having respective values in a range from 0 to 1023, as shown at line 109. A cross-coverage point CR1 is defined as the cross product of the coverage-points CP1 and CP2 at line 111. At line 118, a class object cov of type coverage is instantiated. At line 120, the class object cov is randomized, and at line 121, the covergroup is sampled after the randomization.

With multiple concurrent simulations targeting the same coverage space, a particular bin, such as for either of the coverage-points CP1, CP2, may be hit in more than one simulation. Coverage throughput of the regression run may be increased if unique bins are hit in concurrent simulation runs, which may be possible if each simulation run uses a different functional coverage space to target.

According to examples described herein, a bucketization scheme is implemented by which bins of a functional coverage space are segregated into buckets. Each simulation of one or more concurrent simulations is assigned a respective bucket. The respective simulation targets uncovered space (e.g., holes or uncovered bins) of the assigned bucket until the simulation fully covers the assigned bucket. The assigned bucket may be expanded (e.g., size increased) to include additional bins. The simulation may then target uncovered space of the assigned bucket. The simulation and expansion may be iteratively performed until the assigned bucket is the functional coverage space.

Technical advantages of the present disclosure include, but are not limited to, reduction of overlap of targeted functional coverage space across concurrent simulations. Bucketization causes each simulation to target distinct, separate portions of the functional coverage space initially. This may reduce the overlap of concurrent simulations targeting the same uncovered space. The reduction in overlap may result in faster coverage closure in the regression environment and increase throughput of coverage closure in regressions. Computing resources used by the simulations may therefore be conserved and used more efficiently. Other benefits and advantages may be achieved.

FIG. 1B is computer code of an example testbench according to some examples.

The testbench includes a definition of a class of a functional coverage space according to some examples. This testbench is referenced in the context of various examples below. A class of type coverage_reg is defined starting at line 151 and ending at line 164. A random variable addr1 is declared at line 152. The random variable addr1 is connected to coverage-point CP1_Low_Reg at line 154 and to coverage-point CP2_High_Reg at line 157. The coverage-point CP1_Low_Reg has bins having respective values in a range from 0 to 2047, as shown at line 155, and the coverage-point CP2_High_Reg has bins having respective values in a range from 2048 to 4095, as shown at line 158. At line 166, a class object cov of type coverage_reg is instantiated. At line 168, the class object cov is randomized, and at line 169, the covergroup is sampled after the randomization.

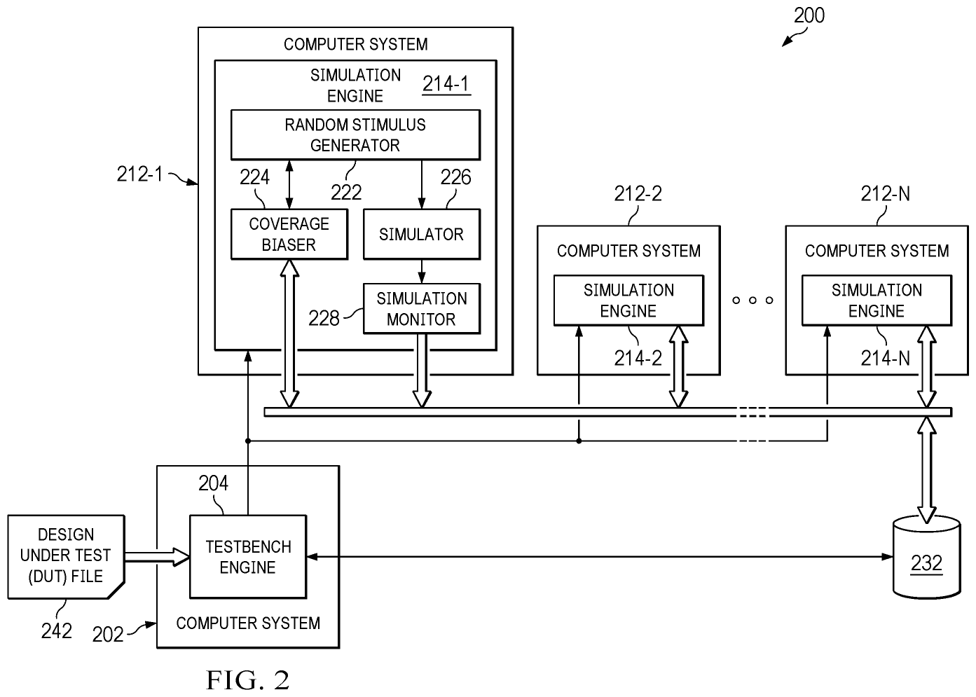

FIG. 2 illustrates a functional verification environment 200 according to some examples. The functional verification environment 200 includes a first computer system 202 on which a testbench engine 204 executes and N number of second computer systems 212-1, 212-2, through 212-N (collectively or individually, “second computer system(s) 212”) on which respective simulation engines 214-1, 214-2, through 214-N (collectively or individually, “simulation engine(s) 214”) execute. The testbench engine 204 may be or include a process executing on a processor of the first computer system 202, and the simulation engines 214 may be or include respective processes executing on respective processors of the second computer systems 212, each processor of which may be different from the processor of the first computer system 202 on which the testbench engine 204 executes. Each simulation engine 214 includes a random stimulus generator 222, a coverage biaser 224, a simulator 226, and a simulation monitor 228, although only the simulation engine 214-1 is illustrated in FIG. 2 as including these components. The functional verification environment 200 also includes a database 232.

The testbench engine 204 is embodied as instructions stored on a non-transitory computer-readable medium, which instructions are executable by one or more processors of the first computer system 202. Similarly, the simulation engine 214 (and components thereof) is embodied as instructions stored on a non-transitory computer-readable medium, which instructions are executable by one or more processors of the respective second computer system 212. Although one simulation engine 214 is shown on a respective second computer system 212, any second computer system 212 may have one or more simulation engine 214 executing or executable thereon.

Each of the random stimulus generator 222, coverage biaser 224, simulator 226, and simulation monitor 228 may be embodied as instructions stored on a non-transitory computer-readable medium, which instructions are executable by one or more processors of the respective second computer system 212. Each of the random stimulus generator 222, coverage biaser 224, simulator 226, and simulation monitor 228 may be a subset of the instructions (e.g., an instruction module) of the respective simulation engine 214.

The instructions embodying the testbench engine 204, when executed by the one or more processors, may perform various functionality described herein. The instructions embodying the respective simulation engine 214, including the random stimulus generator 222, coverage biaser 224, simulator 226, and simulation monitor 228, when executed by the one or more processors, may perform various functionality as described herein.

The testbench engine 204 receives a design under test (DUT) file 242, which includes an electronic (e.g., digital) representation of a DUT. The DUT is a circuit design that is being designed and tested with the objective to manufacture the circuit represented by the circuit design. The DUT file 242 may include a hardware description language (HDL) description, such as Verilog, etc., a register transfer level (RTL) description, a gate-level description, a layout-level description, or the like of the DUT. The testbench engine 204 also obtains (e.g., as a file or as input by a user) a definition of a functional coverage space, such as shown in FIG. 1B as an example. The testbench engine 204 may store the DUT file 242 and definition of the functional coverage space to the database 232.

The testbench engine 204 distributes bins of the functional coverage space into buckets, where each bucket includes multiple bins. Each bin is a range of values of a respective observed variable. For example, the observed variable may fully encompass a range from 0-127. Code in the testbench engine 204 (which may be provided by a user) may distribute the range into bins, for example, such that bin1=[0-31], bin2=[32-63], bin3=[64-95], bin4=[96-127]. The ranges may be specified in any way to meet a target specification, such as by a user distributing the range or the testbench engine 204 automatically distributing the range into a default number of bins. Each bucket has a subset (e.g., a proper subset) of the bins of the functional coverage space. Further, the bins of each bucket are distinct or different from the bins of each other bucket. No bucket includes a bin that is also included in another bucket, and no bin is included in more than one bucket.

Each bucket may be assigned a unique bucket identification (ID) number. The functional coverage space may be distributed into M number of buckets, where each bucket is assigned a respective unique ID number from 1 to M. The testbench engine 204 may distribute the functional coverage space into the buckets based on any distribution scheme. In some examples, the functional coverage space is generally uniformly distributed into the buckets. In such examples, the buckets may have a same S number of bins of the functional coverage space. A given bucket with ID number X may span from bin (S*(X−1)) to bin (S*X−1). Consecutive buckets with ID numbers X and (X+1) may span from bin (S*(X−1)) to bin (S*X−1) and from bin (S*X) to bin (S*(X+1)−1). For example, with an S number of bins being 10, a bucket with ID number 1 includes bin 0 to bin 9; a bucket with ID number 2 includes bin 10 to bin 19; etc. Bins of different coverage points may be numerically concatenated so that bins may be distributed into consecutive buckets. For example, referring to FIG. 1B, CP1_Low_Reg and CP2_High_Reg are numerically concatenated, where CP1_Low_Reg has a lower half range of values (0-2047) of random variable addr1, and CP2_High_Reg has an upper half range of values (2048-4095).

In some examples, the testbench engine 204 may permit a user to input a desired number of bins within each bucket, and the testbench engine 204 may then determine the number of buckets based on the input number of bins within each bucket. In some examples, the testbench engine 204 may permit a user to input a desired number of buckets, and the testbench engine 204 may then determine the number of bins in a bucket based on the input number of buckets. Other distribution schemes may be implemented, such as grouping bins of coverpoints based on value distribution, sampling of similar expressions, or crosses sharing same coverpoints.

The testbench engine 204 may create an object that is stored in the database 232 (which may be a simple file) or other memory that indicates which bins are included in the respective buckets. For example, the object may be indexed by the unique ID number of the bucket to indicate a lower bound and an upper bound of a range of bins included in the respective bucket having that unique ID number.

The testbench engine 204 further initiates simulation engines 214 for concurrent execution of simulation of operation of the DUT. The testbench engine 204 assigns unique ID numbers to the simulation engines 214 as part of the initiation. The testbench engine 204 communicates the unique ID numbers of the simulation to the respective simulation engines 214 upon initiation. The testbench engine 204 may communicate the DUT file 242 to the simulation engines 214 and/or may provide access by the simulation engines 214 to a location in the database 232 where the DUT file 242 is stored. After simulation, the testbench engine 204 may access the database 232 for viewing results of the simulation.

The simulator 226 simulates operation of the DUT. The simulator 226 receives the DUT file 242 (e.g., from the testbench engine 204 or database 232). The simulator 226 simulates operation of the DUT of the DUT file 242 using stimulus values of signals that are output from the random stimulus generator 222.

Generally, the random stimulus generator 222 generates stimulus values as signal input values that are used in the simulation of the operation of the DUT by the simulator 226. In some examples, the random stimulus generator 222 includes a problem generator, a random number generator, and a constraint solver.

The problem generator may produce a constraint problem to be solved. The problem generator may receive a constraints file, which may include declaratory statements of constraints for various signals for which stimulus values are to be generated for simulation. The problem generator may translate the constraints into a form readable by the constraint solver and may dynamically unfold constraints, if any such constraints are included in the constraints file, to generate a constraint problem. The problem generator may output the constraint problem to the constraint solver.

The random number generator may produce random values that may be used as seed values by the constraint solver. The random values may be output from the random number generator to the constraint solver. The constraint solver may query the random number generator to generate and output the random values.

The constraint solver may receive the constraint problem and random values. Based on the received constraint problem and random values, the constraint solver may produce stimulus values of signals that are within the constraints of the constraints file. The constraint solver may solve a constraint problem based on commands from the testbench engine 204. The constraint solver may be or include a constraint satisfiability solver. The generated stimulus values may be applied to respective drivers to simulate operation of the DUT by the simulator 226.

The coverage biaser 224 accesses the database 232 for the bucket assigned to the respective simulation engine 214. Using the unique ID number of the respective simulation engine 214, the coverage biaser 224 may implement a heuristic to determine a unique ID number of a bucket assigned to the respective simulation engine 214. For example, the testbench engine 204 may, upon initializing the respective simulation engine 214, communicate to the simulation engine 214 the unique ID number of the simulation engine 214 and the bucket size (e.g., the number of bins uniformly distributed in each bucket) or number of buckets. The coverage biaser 224 may insert the ID number of the simulation engine 214 and the bucket size or number of buckets into a formula to determine the unique ID number of the bucket assigned to the simulation engine 214. An example formula may be assigned_ID=(sim_ID<<n) % totalBuckets, where assigned_ID is the unique ID of the assigned bucket, sim_ID is the unique ID number of the simulation engine 214, totalBuckets is the number of total buckets, and n is a spacing constant between assigned buckets. For clarity in this example, “<<” indicates a left shift of n bits of sim_ID, and “%” indicates a modulo or remainder operation. Other formulas and heuristics may be implemented. With the unique ID number of the assigned bucket, the coverage biaser 224 may access the object stored in the database 232 to obtain the bins of the assigned bucket. The coverage biaser 224 may have access to the full functional coverage space stored in the database 232 in some examples.

The coverage biaser 224 operates with the random stimulus generator 222 (e.g., the constraint solver) to bias the process (e.g., a constraint satisfiability solver process) implemented by the random stimulus generator 222 to coerce one or more values. The coverage biaser 224 may restrict the random stimulus generator 222 to generate stimulus values that are within the bins of the bucket assigned to the respective simulation engine 214. Further, the coverage biaser 224 may bias the random stimulus generator 222 to generate stimulus values in uncovered bins (e.g., stimulus values not previously simulated) of the bucket assigned to the respective simulation engine 214. If a bin has any value within the range of values of that bin that has not been observed in a simulation (e.g., that has not been covered), then that bin is an uncovered bin. The coverage biaser 224 may implement a machine learning process to identify coverage within the mathematical space available to the stimulus values and to bias the process implemented by the random stimulus generator 222 to coerce the values to diversify generated stimulus values. In some examples, the coverage biaser 224 implementing a machine learning process may be trained based on multiple simulations (e.g., different simulations) such that the coverage biaser 224 may bias the process implemented by the random stimulus generator 222 (e.g., the constraint solver) when the coverage biaser 224 determines that, e.g., the random stimulus generator 222 (e.g., the constraint solver) may be converging on a possible repeated set of stimulus values.

The simulation monitor 228 observes the generated stimulus values output by the random stimulus generator 222 (e.g., as input to the simulator 226) and the state of the DUT during simulation by the simulator 226. The simulation monitor 228 is configured to observe the state of the DUT during simulation. The simulation monitor 228 creates and writes a record of a result of operations of the simulation engine 214 to the database 232. The record may include a trace of the simulation, including the stimulus values. Hence, the simulation monitor 228 may write to the database 232 which bins within the functional coverage space have been covered by simulation.

For a given simulation engine 214, once the simulation engine 214 reaches full coverage of the bins within the bucket assigned to the simulation engine 214 (e.g., each value of the bins within the bucket have been simulated by the simulator 226), the coverage biaser 224 may expand or increase the size of the assigned bucket to include additional bins. For example, with the unique ID number of the assigned bucket, the coverage biaser 224 may access the object stored in the database 232 and overwrite which bins (e.g., such as an upper and/or lower bound of a range of bins) the assigned bucket includes. Expanding or increasing the size of the bucket may permit the bucket to include bins of an adjacent bucket(s) in the functional coverage space. The coverage biaser 224 then biases the random stimulus generator 222 to target uncovered bins within the assigned bucket. When full coverage of the bins within the assigned bucket is reached, the coverage biaser 224 may again expand or increase the size of the assigned bucket. The simulation engine 214 may iteratively continue reaching full coverage of the bins within the assigned bucket and expanding or increasing the size of the assigned bucket until the size of the assigned bucket is the full functional coverage space. In some examples, the size of the assigned bucket is doubled each time the size of the bucket is increased. Other examples may increase the bucket by other amounts.

In some examples, an increase of a size of an assigned bucket may be by changing an upper bound of the range of the assigned bucket to accommodate the increase. The upper bound may be iteratively increased to accommodate the increase of size until the upper bound reaches the upper bound of the full functional coverage space, at which point a lower bound of the range of the assigned bucket may be changed to accommodate the increase. The lower bound may be iteratively decreased to accommodate the increase of size until the lower bound reaches the lower bound of the full functional coverage space. Similarly, in some examples, a lower bound may be iteratively decreased to accommodate the increase of size until the lower bound reaches the lower bound of the full functional coverage space, at which point an upper bound of the range of the assigned bucket may be changed to accommodate the increase. Other examples may simultaneously change an upper bound and a lower bound of the range of the assigned buckets. Any methodology for increasing a size of an assigned bucket may be implemented. Once full coverage of the bucket having the range of the full functional coverage space is reached, simulation may conclude.

Implementing the bucketization scheme may reduce simulation engines 214 simultaneously targeting a same uncovered space within the functional coverage space. Using the buckets, initially, each simulation engine 214 targets a portion (e.g., bins of the assigned respective bucket) of the functional coverage space distinct from the respective portions (e.g., bins of respective buckets) that the other simulation engines 214 target. Hence, at least initially, no overlap of targeting a same uncovered space by different simulation engines 214 occurs. Some overlap of targeting a same uncovered space by different simulation engines 214 may subsequently occur when bucket sizes expand to include the same uncovered space.

Further, in some examples, assigning buckets to the simulation engines 214 with a relatively large number of unassigned buckets consecutively between neighboring assigned buckets may further reduce a probability that a same uncovered space within the functional coverage space is targeted by different simulation engines 214 simultaneously. With a relatively large number of unassigned buckets between neighboring assigned buckets, a given bucket may have to be expanded a number of times before it would overlap another assigned bucket, which may provide sufficient opportunity for the simulation engine 214 to which that other bucket is assigned to fully cover the bins of that bucket. Hence, expanding a bucket to overlap another assigned bucket, in some instances, may not overlap significant uncovered space within the overlapped bucket, which reduces the probability that the same uncovered space is targeted by different simulation engines 214. Hence, in some examples M number of buckets is larger than N number of simulation engines 214 (e.g., concurrent simulations). Further, a larger ratio of M number of buckets to N number of simulation engines 214 may result in a more efficient simulation process.

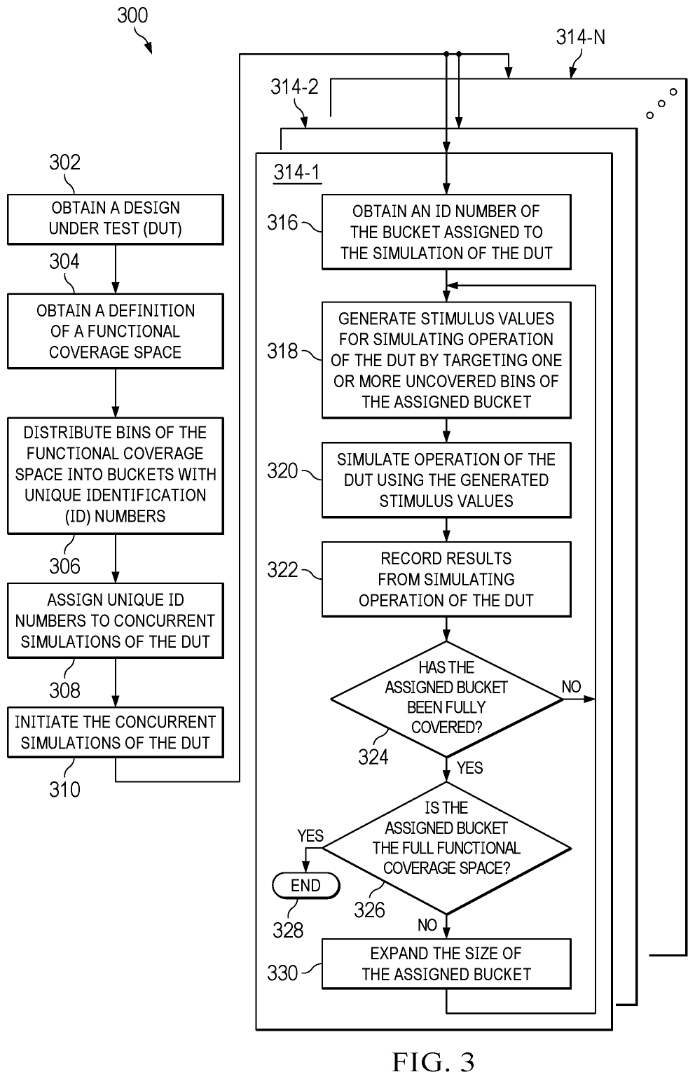

FIG. 3 is a flowchart of a method 300 for functional verification according to some examples. At 302, a DUT is obtained. The DUT may be obtained as a DUT file 242. At 304, a definition of a functional coverage space is obtained. The definition of the functional coverage space may be obtained as a file or as input by a user. At 306, bins of the functional coverage space are distributed into buckets with unique ID numbers. In some examples, distributing the bins may include obtaining a bucket size of the buckets. As described above, the bins may be substantially uniformly distributed among the buckets or may be distributed by any other scheme. At 308, unique ID numbers are assigned to concurrent simulations of the DUT that are to be initiated. At 310, the concurrent simulations of the DUT are initiated. Initiating the concurrent simulations may include communicating the unique ID numbers of the respective concurrent simulations to the respective concurrent simulations. The operations of 302-310 may be performed by the testbench engine 204. The testbench engine 204 may cause the functional coverage space and buckets (with ID numbers) to be stored in the database 232. Additionally, the testbench engine 204 may cause the DUT (e.g., the DUT file 242) to be stored in the database 232. The testbench engine 204 may initiate the concurrent simulations of the DUT on the simulation engines 214.

N number of concurrent simulations 314-1, 314-2, through 314-N (collectively or individually, “simulation(s) 314”) are initiated, e.g., at respective simulation engines 214. Each concurrent simulation 314 is for simulating operation of the DUT. Each simulation 314 includes, at 316, obtaining an ID number of the bucket assigned to the simulation 314 of the DUT. Obtaining the ID number of the bucket may include determining the ID number of the bucket based on the assigned ID number of the simulation 314 of the DUT. Determining the ID number of the assigned bucket may include using a heuristic. The ID number of the simulation 314 may be used in the heuristic to determine the ID number of the assigned bucket. Further, in some examples, a bucket size may be used in the heuristic to determine the ID number of the assigned number.

At 318, stimulus values are generated for simulating operation of the DUT by targeting one or more uncovered bins of the assigned bucket. For example, the coverage biaser 224 may access the functional coverage space from the database 232 and determine uncovered bins within the assigned bucket in the functional coverage space. The coverage biaser 224 biases the random stimulus generator 222 to generate stimulus values that cover the uncovered bins within the assigned bucket.

At 320, operation of the DUT is simulated using the generated stimulus values. For example, the simulator 226 simulates the operation of the DUT using the generated stimulus values as input signals to the DUT. At 322, results from simulating operation of the DUT are recorded. The results may include a trace including the stimulus values. Each simulation engine 214 executing a respective simulation 314 may record the respective results in the database 232; that is, the concurrent simulations 314 may record the respective results in a same database 232. Recording the results indicates which bins have been covered by a simulation.

At 324, a determination of whether the assigned bucket has been fully covered is made. To fully cover a bucket, operation of the DUT has been simulated using stimulus values corresponding to each bin within the bucket. If the determination at 324 is that the bucket has not been fully covered, the simulation 314 iterates to 318 to generate stimulus values by targeting one or more uncovered bins of the assigned bucket, which are used to simulate operation of the DUT at 320. This loop continues until the determination at 324 is that the assigned bucket has been fully covered, at which point, at 326, a determination is made whether the assigned bucket is the full functional coverage space. If the determination at 326 is that the assigned bucket is the full functional coverage space, the simulation 314 terminates at 328. Although the simulation for functional coverage space may terminate at 328, other simulations or operations of a functional verification may continue. If the determination at 326 is that the assigned bucket is not the full functional coverage space, the size of the assigned bucket is expanded at 330, and the simulation 314 iterates to 318 to generate stimulus values by targeting one or more uncovered bins of the assigned bucket, which are used to simulate operation of the DUT at 320. The size of the assigned bucket is expanded at 330 to include additional bins, which may be in other one or more buckets. The size of the bucket may be expanded by any amount. In some examples, the size is doubled. In some instances, the amount to which the assigned bucket may be expanded may be restricted to an upper bound and/or lower bound of the functional coverage space.

As a simple example of the operation of the simulation 314 in FIG. 3, assume five simulations 314 are to be initiated (e.g., on respective simulation engines 214 with ID numbers of 1, 2, 3, 4, and 5, respectively); the functional coverage space has 200 bins (e.g., from bin 0 to bin 199); the bucket size is 10; and bucket size doubles upon completion of full coverage of an assigned bucket. Upon initialization, assume that simulation 314-1 (having ID number 1) is assigned a bucket with an ID number 1 (having a range from bin 0 to bin 9); simulation 314-2 (having ID number 2) is assigned a bucket with an ID number 5 (having a range from bin 40 to bin 49); simulation 314-3 (having ID number 3) is assigned a bucket with an ID number 9 (having a range from bin 80 to bin 89); simulation 314-4 (having ID number 4) is assigned a bucket with an ID number 13 (having a range from bin 120 to bin 129); and simulation 314-5 (having ID number 5) is assigned a bucket with an ID number 17 (having a range from bin 160 to bin 169). Buckets with ID numbers 2-4, 6-8, 10-12, 14-16, 18-20 are not assigned to a simulation 314. Bins 0 through 49 are consecutively between assigned bucket with ID number 1, unassigned buckets with ID numbers 2-4, and assigned bucket with ID number 5; Bins 40 through 89 are consecutively between assigned bucket with ID number 5, unassigned buckets with ID numbers 6-8, and assigned bucket with ID number 9; etc.

Referring to simulation 314-1, stimulus values are generated at 318, operation of the DUT is simulated at 320, and results are recorded at 322 until the bins 0 to 9 of the bucket with the ID number 1 are fully covered. Then, the size of the bucket with the ID number 1 is expanded or increased at 330 to have a range from bin 0 to bin 19. Then, stimulus values are generated at 318, operation of the DUT is simulated at 320, and results are recorded at 322 until the bins 0 to 19 of the bucket with the ID number 1 are fully covered. Then, the size of the bucket with the ID number 1 is expanded or increased at 330 to have a range from bin 0 to bin 39. Then, stimulus values are generated at 318, operation of the DUT is simulated at 320, and results are recorded at 322 until the bins 0 to 39 of the bucket with the ID number 1 are fully covered.

The bucket with the ID number 1 is then expanded or increased at 330 to have a range from bin 0 to bin 79. At this point, the bucket is expanded or increased to overlap the bucket with the ID number 5 assigned to the simulation 314-2. Depending on the progression of the simulation 314-2, the overlap of the buckets with respective ID numbers 1 and 5 may be fully covered from the simulation 314-2. If the overlap of the buckets with respective ID numbers 1 and 5 includes uncovered bins, the uncovered bins may be simultaneously targeted at 318 by different simulations 314-1, 314-2. By having sufficient number of unassigned buckets initially between the assigned buckets with respective ID numbers 1 and 5 may permit the simulation 314-2 to progress such that when the assigned buckets with respective ID numbers 1 and 5 overlap, the overlap is fully covered, which may increase efficiency of the simulations 314. The buckets assigned to the simulations 314 may similarly be expanded or increased, and the simulations 314 may progress, until the buckets reach the full functional coverage space.

A tested example had two coverage points and a cross coverage point. The two coverage points were connected to random variables with 2048 and 1024 bins, respectively. The cross coverage point had 2 million bins. When the functional coverage space is targeted using the bucketization scheme with 32 concurrent simulations and 1024 randomizations and sampling per simulation, approximately 7000 simulations run to reach a 100% coverage goal. The bucketization scheme provided a gain of 125% over simulations that did not implement the bucketization scheme.

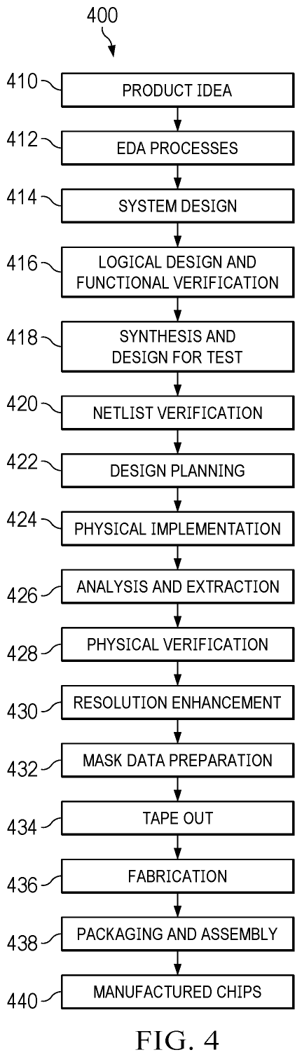

FIG. 4 illustrates an example set of processes 400 used during the design, verification, and fabrication of an article of manufacture such as an integrated circuit to transform and verify design data and instructions that represent the integrated circuit. Each of these processes can be structured and enabled as multiple modules or operations. The term ‘EDA’ signifies the term ‘Electronic Design Automation.’ These processes start with the creation of a product idea 410 with information supplied by a designer, information which is transformed to create an article of manufacture that uses a set of EDA processes 412. When the design is finalized, the design is taped-out 434, which is when artwork (e.g., geometric patterns) for the integrated circuit is sent to a fabrication facility to manufacture the mask set, which is then used to manufacture the integrated circuit. After tape-out, a semiconductor die is fabricated 436 and packaging and assembly processes 438 are performed to produce the finished integrated circuit 440.

Specifications for a circuit or electronic structure may range from low-level transistor material layouts to high-level description languages. A high-level of representation may be used to design circuits and systems, using a hardware description language (HDL) such as VHDL, Verilog, System Verilog, SystemC, MyHDL or Open Vera. The HDL description can be transformed to a logic-level register transfer level (RTL) description, a gate-level description, a layout-level description, or a mask-level description. Each lower representation level that is a more detailed description adds more useful detail into the design description, for example, more details for the modules that include the description. The lower levels of representation that are more detailed descriptions can be generated by a computer, derived from a design library, or created by another design automation process. An example of a specification language at a lower level of representation language for specifying more detailed descriptions is SPICE, which is used for detailed descriptions of circuits with many analog components. Descriptions at each level of representation are enabled for use by the corresponding systems of that layer (e.g., a formal verification system). A design process may use a sequence depicted in FIG. 4. The processes described by be enabled by EDA products (or EDA systems).

During system design 414, functionality of an integrated circuit to be manufactured is specified. The design may be optimized for desired characteristics such as power consumption, performance, area (physical and/or lines of code), and reduction of costs, etc. Partitioning of the design into different types of modules or components can occur at this stage.

During logic design and functional verification 416, modules or components in the circuit are specified in one or more description languages and the specification is checked for functional accuracy. For example, the components of the circuit may be verified to generate outputs that match the requirements of the specification of the circuit or system being designed. Functional verification may use simulators and other programs such as testbench generators, static HDL checkers, and formal verifiers. In some embodiments, special systems of components referred to as ‘emulators’ or ‘prototyping systems’ are used to speed up the functional verification.

During synthesis and design for test 418, HDL code is transformed to a netlist. In some embodiments, a netlist may be a graph structure where edges of the graph structure represent components of a circuit and where the nodes of the graph structure represent how the components are interconnected. Both the HDL code and the netlist are hierarchical articles of manufacture that can be used by an EDA product to verify that the integrated circuit, when manufactured, performs according to the specified design. The netlist can be optimized for a target semiconductor manufacturing technology. Additionally, the finished integrated circuit may be tested to verify that the integrated circuit satisfies the requirements of the specification.

During netlist verification 420, the netlist is checked for compliance with timing constraints and for correspondence with the HDL code. During design planning 422, an overall floor plan for the integrated circuit is constructed and analyzed for timing and top-level routing.

During layout or physical implementation 424, physical placement (positioning of circuit components such as transistors or capacitors) and routing (connection of the circuit components by multiple conductors) occurs, and the selection of cells from a library to enable specific logic functions can be performed. As used herein, the term ‘cell’ may specify a set of transistors, other components, and interconnections that provides a Boolean logic function (e.g., AND, OR, NOT, XOR) or a storage function (such as a flipflop or latch). As used herein, a circuit ‘block’ may refer to two or more cells. Both a cell and a circuit block can be referred to as a module or component and are enabled as both physical structures and in simulations. Parameters are specified for selected cells (based on ‘standard cells’) such as size and made accessible in a database for use by EDA products.

During analysis and extraction 426, the circuit function is verified at the layout level, which permits refinement of the layout design. During physical verification 428, the layout design is checked to ensure that manufacturing constraints are correct, such as DRC constraints, electrical constraints, lithographic constraints, and that circuitry function matches the HDL design specification. During resolution enhancement 430, the geometry of the layout is transformed to improve how the circuit design is manufactured.

During tape-out, data is created to be used (after lithographic enhancements are applied if appropriate) for production of lithography masks. During mask data preparation 432, the ‘tape-out’ data is used to produce lithography masks that are used to produce finished integrated circuits.

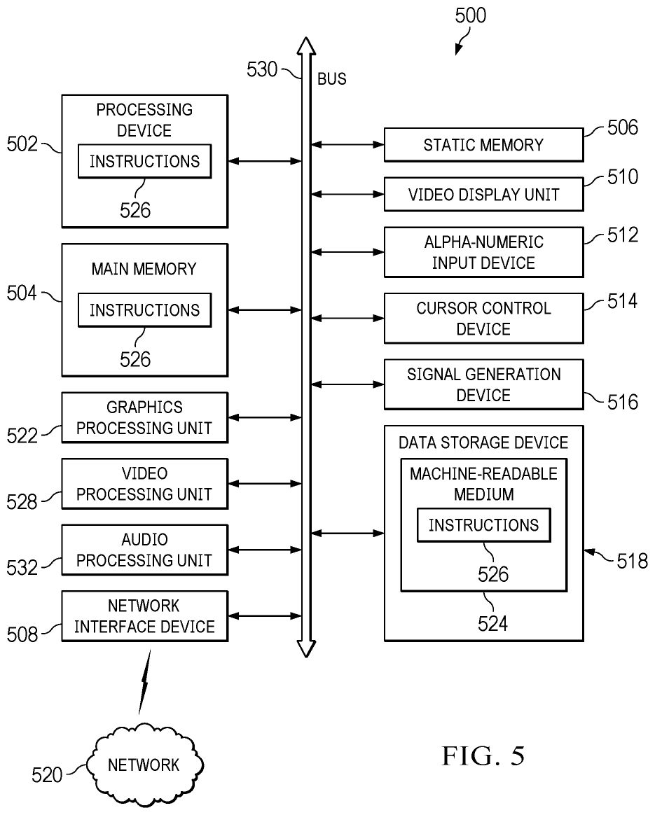

A storage subsystem of a computer system (such as computer system 500 of FIG. 5) may be used to store the programs and data structures that are used by some or all of the EDA products described herein, and products used for development of cells for the library and for physical and logical design that use the library.

FIG. 5 illustrates an example machine of a computer system 500 within which a set of instructions, for causing the machine to perform any one or more of the methodologies discussed herein, may be executed. In alternative implementations, the machine may be connected (e.g., networked) to other machines in a LAN, an intranet, an extranet, and/or the Internet. The machine may operate in the capacity of a server or a client machine in client-server network environment, as a peer machine in a peer-to-peer (or distributed) network environment, or as a server or a client machine in a cloud computing infrastructure or environment.

The machine may be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 500 includes a processing device 502, a main memory 504 (e.g., read-only memory (ROM), flash memory, dynamic random access memory (DRAM) such as synchronous DRAM (SDRAM), a static memory 506 (e.g., flash memory, static random access memory (SRAM), etc.), and a data storage device 518, which communicate with each other via a bus 530.

Processing device 502 represents one or more processors such as a microprocessor, a central processing unit, or the like. More particularly, the processing device may be complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 502 may also be one or more special-purpose processing devices such as an application specific integrated circuit (ASIC), a field programmable gate array (FPGA), a digital signal processor (DSP), network processor, or the like. The processing device 502 may be configured to execute instructions 526 for performing the operations and steps described herein.

The computer system 500 may further include a network interface device 508 to communicate over the network 520. The computer system 500 also may include a video display unit 510 (e.g., a liquid crystal display (LCD) or a cathode ray tube (CRT)), an alphanumeric input device 512 (e.g., a keyboard), a cursor control device 514 (e.g., a mouse), a graphics processing unit 522, a signal generation device 516 (e.g., a speaker), graphics processing unit 522, video processing unit 528, and audio processing unit 532.

The data storage device 518 may include a machine-readable storage medium 524 (also known as a non-transitory computer-readable storage medium) on which is stored one or more sets of instructions 526 or software embodying any one or more of the methodologies or functions described herein. The instructions 526 may also reside, completely or at least partially, within the main memory 504 and/or within the processing device 502 during execution thereof by the computer system 500, the main memory 504 and the processing device 502 also constituting machine-readable storage media.

In some implementations, the instructions 526 include instructions to implement functionality corresponding to the present disclosure. While the machine-readable storage medium 524 is shown in an example implementation to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instructions for execution by the machine and that cause the machine and the processing device 502 to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm may be a sequence of operations leading to a desired result. The operations are those requiring physical manipulations of physical quantities. Such quantities may take the form of electrical or magnetic signals capable of being stored, combined, compared, and otherwise manipulated. Such signals may be referred to as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the present disclosure, it is appreciated that throughout the description, certain terms refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices.

The present disclosure also relates to an apparatus for performing the operations herein. This apparatus may be specially constructed for the intended purposes, or it may include a computer selectively activated or reconfigured by a computer program stored in the computer. Such a computer program may be stored in a non-transitory computer-readable storage medium, such as, but not limited to, any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions, each coupled to a computer system bus.

The algorithms and displays presented herein are not inherently related to any particular computer or other apparatus. Various other systems may be used with programs in accordance with the teachings herein, or it may prove convenient to construct a more specialized apparatus to perform the method. In addition, the present disclosure is not described with reference to any particular programming language. It will be appreciated that a variety of programming languages may be used to implement the teachings of the disclosure as described herein.

The present disclosure may be provided as a computer program product, or software, that may include a machine-readable storage medium having stored thereon instructions, which may be used to program a computer system (or other electronic devices) to perform a process according to the present disclosure. A machine-readable storage medium includes any mechanism for storing information in a form readable by a machine (e.g., a computer). For example, a machine-readable (e.g., a computer-readable) storage medium includes a machine-readable (e.g., a computer-readable) storage medium such as a read only memory (ROM), random access memory (RAM), magnetic disk storage media, optical storage media, flash memory devices, etc.

An example is a non-transitory computer-readable storage medium including stored instructions. The instructions, which when executed by one or more processors, cause the one or more processors to: obtain an assignment of an assigned bucket; generate stimulus values targeting one or more uncovered bins of the assigned bucket; simulate operation of a circuit design using the stimulus values; determine whether the assigned bucket has been covered by the simulated operation of the circuit design; and expand a size of the assigned bucket following a determination that the assigned bucket has been covered. The assigned bucket, as assigned, has a subset of bins of a functional coverage space.

Another example is a system including a memory and a processor. The memory stores instructions. The processor is coupled with the memory and is to execute the instructions. The instructions when executed cause the processor to: obtain a definition of a functional coverage space for simulation of a circuit design; distribute bins of the functional coverage space into respective buckets; assign identification numbers to concurrent simulations to be initiated; and initiate the concurrent simulations including transmitting the identification numbers to the respective concurrent simulations. Each bucket of the buckets has a proper subset of the bins of the functional coverage space distinct from each other bucket of the buckets.

A further example is a method. Operation of a circuit design is simulated using concurrent processes on respective first processors. Each concurrent process of the concurrent processes includes: obtaining an assignment of an assigned bucket and iteratively until the assigned bucket is the functional coverage space: (i) iteratively until the assigned bucket has been fully covered: (a) generating stimulus values for simulating operation of the circuit design by targeting one or more uncovered bins of the assigned bucket; (b) simulating operation of the circuit design using the stimulus values; and (c) recording a result of simulating operation of the circuit design; and (ii) expanding a size of the assigned bucket to include additional bins of the functional coverage space. The assigned bucket of the respective concurrent process has a subset of bins of a functional coverage space that is distinct from each assigned bucket of the other concurrent processes.

In the foregoing disclosure, implementations of the disclosure have been described with reference to specific example implementations thereof. It will be evident that various modifications may be made thereto without departing from the broader spirit and scope of implementations of the disclosure as set forth in the following claims. Where the disclosure refers to some elements in the singular tense, more than one element can be depicted in the figures and like elements are labeled with like numerals. The disclosure and drawings are, accordingly, to be regarded in an illustrative sense rather than a restrictive sense.

What is claimed is:

1. A non-transitory computer-readable storage medium comprising stored instructions, which when executed by one or more processors, cause the one or more processors to:
obtain an assignment of an assigned bucket, wherein the assigned bucket has a subset of bins of a functional coverage space;
generate stimulus values targeting one or more uncovered bins of the assigned bucket;
simulate operation of a circuit design using the stimulus values;
determine whether the assigned bucket has been covered by the simulated operation of the circuit design; and
expand a size of the assigned bucket following a determination that the assigned bucket has been covered.

2. The non-transitory computer-readable storage medium of claim 1, wherein the instructions, which when executed by the one or more processors, cause the one or more processors to: generate the stimulus values, and simulate the operation of the circuit design iteratively until the assigned bucket has been covered.

3. The non-transitory computer-readable storage medium of claim 2, wherein the instructions, which when executed by the one or more processors, cause the one or more processors to: iteratively expand the size of the assigned bucket following respective determinations that the assigned bucket has been covered until the assigned bucket is the functional coverage space.

4. The non-transitory computer-readable storage medium of claim 1, wherein the bins of the functional coverage space are distributed into distinct buckets, the assigned bucket being a bucket of the distinct buckets, a neighboring bucket of the distinct buckets that neighbors the assigned bucket being unassigned.

5. The non-transitory computer-readable storage medium of claim 1, wherein the instructions, which when executed by the one or more processors, cause the one or more processors to obtain the assignment of the assigned bucket includes instructions, which when executed by the one or more processors, cause the one or more processors to determine the assigned bucket using a heuristic.

6. The non-transitory computer-readable storage medium of claim 1, wherein the instructions, which when executed by the one or more processors, cause the one or more processors to: record a result of the simulation of the operation of the circuit design.

7. A system comprising:
a memory storing instructions; and
a processor, coupled with the memory and to execute the instructions, the instructions when executed cause the processor to:
obtain a definition of a functional coverage space for simulation of a circuit design;
distribute bins of the functional coverage space into respective buckets, each bucket of the buckets having a proper subset of the bins of the functional coverage space distinct from each other bucket of the buckets;
assign identification numbers to concurrent simulations to be initiated; and
initiate the concurrent simulations including transmitting the identification numbers to the respective concurrent simulations.

8. The system of claim 7, wherein the bins are distributed uniformly in the buckets.

9. The system of claim 7, wherein a number of the buckets is larger than a number of the concurrent simulations.

10. A method comprising:
simulating operation of a circuit design using concurrent processes on respective first processors, wherein each concurrent process of the concurrent processes includes:
obtaining an assignment of an assigned bucket, wherein the assigned bucket of the respective concurrent process has a subset of bins of a functional coverage space that is distinct from each assigned bucket of the other concurrent processes; and
iteratively until the assigned bucket is the functional coverage space:
iteratively until the assigned bucket has been fully covered:
generating stimulus values for simulating operation of the circuit design by targeting one or more uncovered bins of the assigned bucket;
simulating operation of the circuit design using the stimulus values; and
recording a result of simulating operation of the circuit design; and
expanding a size of the assigned bucket to include additional bins of the functional coverage space.

11. The method of claim 10, further comprising:
obtaining a definition of the functional coverage space; and
distributing the bins of the functional coverage space into buckets, each bucket of the buckets having a subset of the bins of the functional coverage space that is distinct from each other bucket of the buckets, wherein the assigned bucket of each concurrent process of the concurrent processes is a respective bucket of the buckets.

12. The method of claim 11, wherein the bins are distributed uniformly into the buckets.

13. The method of claim 11, wherein a number of the buckets is larger than a number of the concurrent processes.

14. The method of claim 11, wherein some of the buckets are not assigned to any of the concurrent processes.

15. The method of claim 11, wherein for each pair of neighboring buckets assigned to respective ones of the concurrent processes, multiple unassigned buckets are between the respective pair of neighboring buckets, bins of the functional coverage space being consecutive between the respective pair of neighboring buckets and the multiple unassigned buckets.

16. The method of claim 11, wherein distributing the bins into the buckets further includes assigning unique bucket identification (ID) numbers to the buckets.

17. The method of claim 16, wherein, for each concurrent process of the concurrent processes, obtaining the assigned bucket includes determining a respective unique bucket ID number of the assigned bucket from the unique bucket ID numbers using a heuristic.

18. The method of claim 17, further comprising assigning unique simulation ID numbers to the concurrent processes, wherein, for each concurrent process of the concurrent processes, the heuristic uses the respective unique simulation ID number of the respective concurrent process.

19. The method of claim 11, wherein obtaining the definition of the functional coverage space and distributing the bins of the functional coverage space into the buckets are performed by a process on a second processor different from each processor of the first processors.

20. The method of claim 10, wherein recording the result of simulating operation of the circuit design includes writing the result to a database, the concurrent processes writing the result to a same database.
